(19) United States
(12) Patent Application Publication
(10) Pub. No.: US 2011/0159462 A1
(43) Pub. Date: Jun. 30, 2011

(54) THERAPEUTIC AGENT FOR PERIODONTAL DISEASES AND METHOD OF TREATING PERIODONTAL DISEASES

(75) Inventors: Hirofumi Asano, Tokyo (JP); Takanori Wada, Yamaguchi (JP); Kazuo Komiyama, Chiba (JP)

(73) Assignee: HIROFUMI ASANO, Tokyo (JP)

(21) Appl. No.: 12/977,255

(22) Filed: Dec. 23, 2010

(30) Foreign Application Priority Data
Dec. 25, 2009 (JP) 2009-295263

(51) Int. Cl. A61C 5/04

(52) U.S. Cl. 433/228.1

(57) ABSTRACT

A therapeutic agent is provided for periodontal diseases by which a biofilm formed inside hard tissues in an oral cavity is removed and the hard tissues are re-calcified. The biofilm formed in a fine fracture within contaminated tooth hard tissues is chemically dissolved and removed and calcium ions contained in the biofilm are precipitated as a calcium salt under an alkali condition so that the anatomically present fine fracture is sealed by the precipitated salt.

### BACKGROUND OF THE INVENTION

1. Field of the Invention

The present invention relates to a therapeutic agent for periodontal diseases and a method of treating periodontal diseases which can remove contaminants within a periodontal pocket, which have developed into a periodontal disease, and can seal a fine fracture within cementum by calcium salt.

2. Description of the Related Art

Conventionally, treatment of periodontal diseases is performed according to a method by which contaminated cementum within a periodontal pocket is mechanically removed by using a scaler, etc. and the inside of the periodontal pocket is washed with a mouth washing liquid containing a surface active agent. Since then, depending on the specific case, performing a treatment using a local drug delivery system (LDDS) with a sustained-release tetracycline preparation is established as a modern method of the treatment.

However, as the contaminated cementum is present within a periodontal pocket, mechanical removal of the contaminated cementum by a dentist using a scaler, etc. is often accompanied by damage of the epithelium of a periodontal pocket, etc. during the treatment. Further, as infiltration injection of anesthesia to gingiva, etc. is required as a treatment for relieving pain, a huge mental burden is imposed on a patient who is afraid of injection. In addition, due to complex anatomical system of root surface, it takes a long time to remove mechanically the contaminated cementum, thus imposing a big burden on a patient.

Furthermore, as a conventional technology of preventing periodontal diseases, Japanese Patent No. 4022237 discloses an oral cavity disinfectant containing a mixture of sodium hypochlorite at a concentration of 100 ppm to 200 ppm and sodium hydroxide at a concentration of 150 ppm to 300 ppm.

Still furthermore, Japanese Patent No. 4369530 discloses dental sterilizing water containing the effective chlorine concentration of 50 ppm to 700 ppm from hypochlorous acid and sodium hydrogen carbonate and a pH of 6.3 to 8.

In general, an antibacterial agent for periodontitis is used under the assumption that periodontal pathogens do not simply stay at a biofilm on tooth surface but infiltrate the cells of a periodontal tissue. However, components of a biofilm consist of various organic molecules like proteins, sugars, oils and fats, etc., and considering the action mechanism of an antibiotic substrate, it is difficult to say that it is an appropriate choice for degradation and removal of a biofilm.

Furthermore, from the anatomical point of view, a vascular system does not exist in healthy cementum, and cementum cells within the cementum are supplied with nutrients from periodontal membrane based on penetrant diffusion. When the anatomical characteristics are considered, in contaminated cementum existing in a periodontal pocket which develops into periodontal diseases, various antigenic substances that are present in the periodontal pocket have infiltrated. Thus, even when the surface of the contaminated cementum is completely removed by a mechanical means, the antigenic substance as a contaminant is still present as a biofilm in the remaining cementum, and it means that the antigens released therefrom keep causing inflammation in the periodontal pocket based on an antigen-antibody reaction. For such reasons, it has been necessary to visit a hospital for a long period of time to treat the periodontal diseases.

Furthermore, the related art technology that is described in Japanese Patent No. 4022237 is problematic in that, as having a mixed aqueous solution at low concentration, the application area is limited to a surface of hard tissues in an oral cavity and it is unable to remove a biofilm which is formed in contaminated cementum. Still furthermore, the related art technology that is described in Japanese Patent No. 4369530 is problematic in that, as related to dental sterilizing water for dental use having a pH of 6.3 to 8, it has almost no contribution to the removal of a biofilm.

### SUMMARY OF THE INVENTION

The present invention has been made in view of the problems described above and an object of the present invention is to provide a therapeutic agent for periodontal diseases and a method of treating periodontal disease that is not so painful for a patient and useful for inhibiting the relapse of periodontal diseases by chemically dissolving and removing a biofilm formed inside periodontal tissues and sealing fine cracks.

According to a first aspect of the present invention, there is provided a therapeutic agent for periodontal diseases by which a biofilm formed inside hard tissues in an oral cavity is removed and the hard tissues are re-calcified, in which the biofilm formed in a fine fracture within contaminated tooth hard tissues is chemically dissolved and removed and calcium ions contained in the biofilm are precipitated as a calcium salt under an alkali condition so that the anatomically present fine fracture is sealed by the precipitated salt.

This aspect is to chemically remove contaminants in contaminated cementum and seal fine fracture structures in the contaminated cementum by calcification. Specifically, by infiltrating contaminated cementum with the aqueous solution of the present invention, contaminants formed inside the contaminated cementum are dissolved and removed, and based on the activity of an alkali component in the residual aqueous solution to precipitate calcium salts, the fine structures in the cementum are sealed. As a result, not only the biofilm in hard tissues is removed but also the hard tissues are re-calcified to prevent the relapse of periodontal diseases.

According to a second aspect of the present invention, in the therapeutic agent for periodontal diseases, it is preferable that the therapeutic agent for periodontal diseases be an aqueous solution comprising hypochlorous acid or sodium hypochlorite, and the aqueous solution has an effective chlorine concentration of 0.1 ppm to 100000 ppm and a pH value of 7 to 13 and contains the sodium hypochlorite or sodium dichloroisocyanurate, and sodium hydroxide, sodium hydrogen carbonate or sodium carbonate.

With respect to hypochlorous acid (sodium hypochlorite), it has been already shown that in washing of a biofilm the washing power of sodium hypochlorite is dependent on the concentration of OCl⁻ and the washing effect is improved as pH increases. In particular, at the concentration of 100 mg/L (100 ppm) or above, the washing effect is improved. With respect to the washing effect of a hydroxide ion (OH⁻), it is also reported that the removal ratio of a biofilm is dependent on OH⁻ concentration. Although the dissolution ratio is low in a neutral to alkali region, in the range of pH 11 to pH 13 the washing effect is dramatically improved in accordance with the increase in OH⁻ concentration. Thus, it becomes possible to ensure the human safety and increase dramatically the biofilm removal ratio.

According to a third aspect of the present invention, in the therapeutic agent for periodontal diseases, it is preferable that the aqueous solution be an aqueous electrolyte solution and an equilibrium state is determined by the pH value.

The aqueous solution of this aspect has a property of an electrolyte solution and its pH is changed even to a neutral region according to neutralization by proteins, etc. that are included in saliva or a biofilm, etc. during treatment. At that moment, according to Le Chatelier's principle, there is a tendency for the aqueous solution to obtain a new equilibrium state. Thus, even when the aqueous solution passes through an oral cavity and enters a stomach, it is neutralized by stomach acid (pH 2), and therefore a bad influence on a human body can be prevented.

According to a fourth aspect of the present invention, in the therapeutic agent for periodontal diseases, it is preferable that a non-ionic surface active agent be added to the aqueous solution.

By having and using a small amount of a non-ionic surface active agent, contaminants are converted into colloid by the surface active agent, and therefore their re-adsorption is inhibited. As a result, the washing effect can be enhanced.

According to a fifth aspect of the present invention, it is preferable that the biofilm formed inside the hard tissue be removed by infiltrating a periodontal pocket having contaminated cementum with the therapeutic agent for periodontal diseases according to any one of the above aspects.

Washing is carried out by applying the aqueous solution of the present invention on a surface of contaminated cementum so that it can infiltrate in the contaminated cementum. By doing so, a contaminant (i.e., a biofilm) present in fine structures can be removed and the fine structures can be sealed by precipitation of calcium salts by an action of residual high alkali components, and as a result, it becomes possible to inhibit the relapse.

### BRIEF DESCRIPTION OF THE DRAWINGS

FIG. 1 is a cross-sectional view of a periodontal tissue;

FIG. 2 is a microscopic image illustrating the surroundings around cellular cementum;

FIG. 3 is a partially enlarged view illustrating cementum lacuna;

FIG. 4 is a diagram illustrating an effect of pH of a washing liquid on desorption of BSA that is irreversibly adsorbed on a surface of α-Al₂O₃ and desorption of biofilm-forming bacteria;

FIG. 5 is a diagram illustrating a model mechanism of washing and removing components of a biofilm by OH⁻; and

FIG. 6 is a diagram illustrating a comparison result of an effect between a conventional oral cavity disinfectant and a therapeutic agent for periodontal diseases of the present invention.

### DESCRIPTION OF THE PREFERRED EMBODIMENTS

Hereinbelow, exemplary embodiments of the present invention will be described in detail with reference to the accompanying drawings. However, unless specifically described otherwise, the constitutional elements, types, combinations, shapes, their relative disposition, and the like are not the gist by which the scope of the present invention is limited but mere explanatory examples.

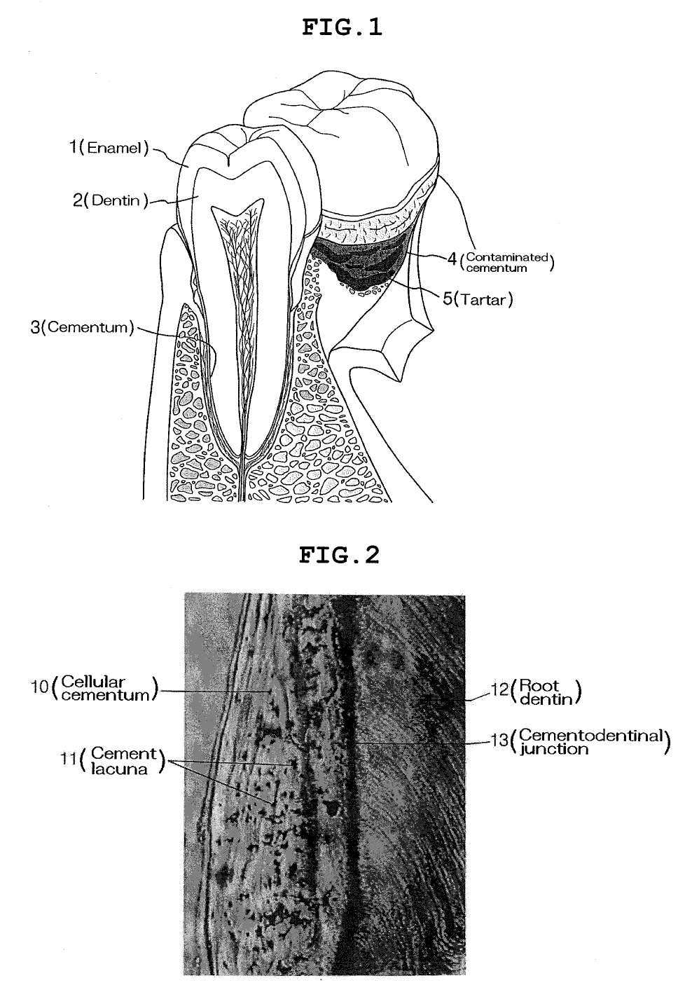

FIG. 1 is a cross-sectional view of a periodontal tissue. A tooth consists of hard tissues including, starting from the surface, enamel 1, dentin 2, and cementum 3. FIG. 1 illustrates a state in which contaminated cementum 4 is influenced by a periodontal disease. In particular, the cementum 3 is a calcified tissue in which cementoblasts originating from dental follicle are formed and added in the layer form on the surface of tooth root, and as residing within a tooth socket, it cannot be visually observed. Although the cementum 3 has a broad borderline with the dentin 2 of root portion of the tooth, it may be also in contact with the enamel 1 of a tooth crown part.

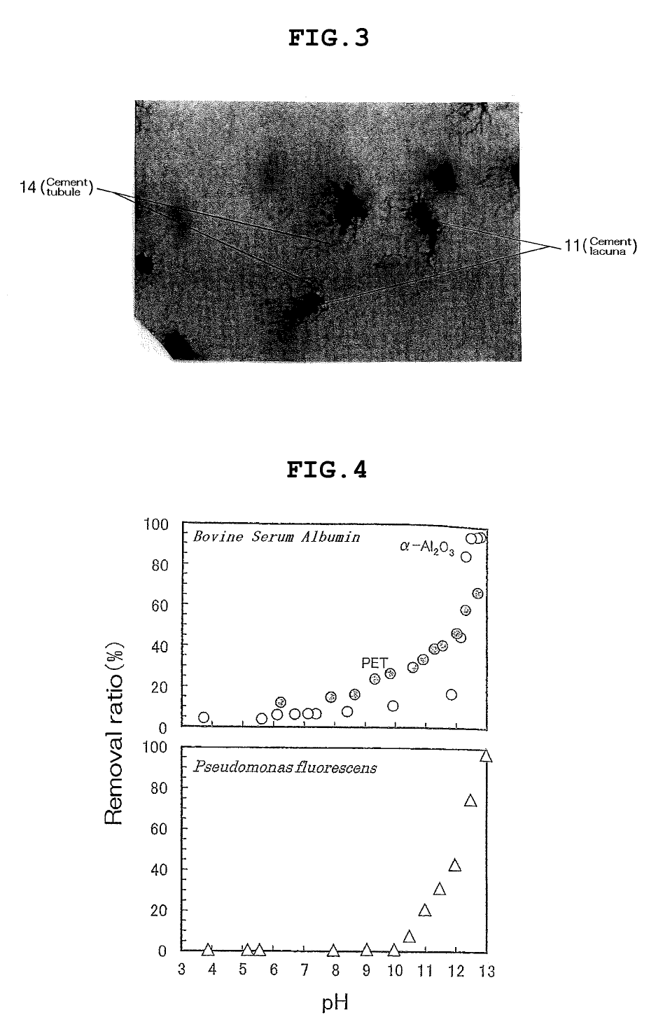

From the anatomical point of view, no vascular system is present in healthy cementum. A cement tubule 14 in the cementum 3 (see, FIG. 3) receives nutrients from a periodontal membrane based on penetrant diffusion. Considering such anatomical characteristics, the contaminated cementum 4, which is present within a periodontal pocket and developed into a periodontal disease, is infiltrated with various antigenic substances that are present in the periodontal pocket. This means that, even when the surface of the contaminated cementum 4 is completely removed by a mechanical means, the antigenic substance as a contaminant is present as a biofilm within the remaining cementum, and the antigen released therefrom keeps causing inflammation in the periodontal pocket based on an antigen-antibody reaction. Thus, for the treatment of periodontal diseases, it was necessary to visit a dental office for a long period of time.

Therefore, an object of the present invention is to efficiently perform the removal of an antigenic substance present in a periodontal tissue, which is also referred to as cementum, while having little pain for a patient, and inhibiting the relapse by chemically dissolving and removing a biofilm formed inside the periodontal tissue and sealing fine cracks. Furthermore, when it is developed into dental caries and dentin is contaminated, the biofilm which is formed in dentinal tubule inside the contaminated dentin is a subject. Still furthermore, in case of enamel, the biofilm which is formed in fractures in enamel rod (prism) is a subject.

In order to solve the problems above, a biofilm formed in fine fractures within the contaminated tooth hard tissues is chemically dissolved and removed and calcium ions contained in the biofilm are precipitated as a calcium salt under an alkali condition, and therefore the anatomically present fine fractures are sealed by the calcium salts.

Specifically, the removal of the contaminants in the contaminated cementum 4 and the sealing of the fine fracture structure in the contaminated cementum 4 by calcification are performed chemically. For this, the contaminated cementum 4 is infiltrated with the therapeutic agent for periodontal diseases of the present invention as mentioned below to dissolve and remove the contaminants formed inside the contaminated cementum 4, and the fine structures within the cementum 3 are sealed according to precipitation of calcium salts by the alkali component present in the residual aqueous solution. As a result, not only the biofilm in hard tissues is removed but also the hard tissues are re-calcified to prevent the relapse of periodontal diseases.

Furthermore, the therapeutic agent for periodontal diseases of the present invention is an aqueous solution comprising hypochlorous acid or sodium hypochlorite, and the aqueous solution has an effective chlorine concentration of 0.1 ppm to 100000 ppm and a pH of 7 to 13 and contains the sodium hypochlorite or sodium dichloroisocyanurate, and sodium hydroxide, sodium hydrogen carbonate or sodium carbonate. Specifically, with respect to hypochlorous acid (sodium hypochlorite), it has been already shown that in washing of a biofilm the washing power of sodium hypochlorite is dependent on the concentration of OCl⁻ and the washing effect is improved as pH increases. In particular, at the concentration of 100 mg/L (100 ppm) or above, the washing effect is improved. With respect to the washing effect of a hydroxide ion (OH⁻), it is also reported that the removal ratio of a biofilm is dependent on OH⁻ concentration. Although the dissolution ratio is low in a neutral to alkali region, in the range of pH 11 to pH 13 the washing effect is dramatically improved in accordance with the increase in OH⁻ concentration. Thus, it is possible to ensure the human safety and increase dramatically the biofilm removal ratio.

Furthermore, the aqueous solution of the present invention is an aqueous electrolyte solution and an equilibrium state is determined by the pH value described above. Specifically, the aqueous solution of the present invention has a property of an electrolyte solution and its pH is changed even to a neutral region according to neutralization by proteins, etc. that are included in saliva or a biofilm, etc. during treatment. At that moment, according to Le Chatelier's principle, there is a tendency for the aqueous solution to obtain a new equilibrium state. Thus, even when the aqueous solution passes through an oral cavity and enters a stomach, it is neutralized by stomach acid (pH 2), and therefore a bad influence on a human body can be prevented.

Furthermore, a non-ionic surface active agent was added to the aqueous solution of the present invention. Specifically, by having and using a small amount of a non-ionic surface active agent, contaminants are converted into colloid by the surface active agent, and therefore their re-adsorption is inhibited. As a result, the washing effect can be enhanced.

Still furthermore, a biofilm formed inside the hard tissue is removed by having a periodontal pocket with the contaminated cementum 4 infiltrated with the therapeutic agent for periodontal diseases of the present invention. Specifically, washing is carried out by applying the aqueous solution of the present invention on a surface of the contaminated cementum 4 so that it can infiltrate in the contaminated cementum 4. By doing so, a contaminant (i.e., a biofilm) present in fine structures can be removed and the fine structures can be sealed by precipitation of calcium salts by an action of residual high alkali components, and as a result, it becomes possible to inhibit the relapse.

Next, a therapy of removing contaminants that are contained in substantia of tooth hard tissues will be explained.

Washing is carried out by applying the aqueous solution of the present invention on the surface of the contaminated cementum 4 for its infiltration into the contaminated cementum 4. Embedded Sharpey's fiber bundles are present on top layer of cementum, while fine structures like cement lacuna 11 and cement tubule 14, etc. are present inside the cementum (see, FIG. 2 and FIG. 3: cited from page 66 of “Oral Histology and Embryology,” Wakaba Publishing Company, published on Sep. 26, 2001).

According to the aqueous solution of the present invention, by removing a contaminant (i.e., a biofilm) present in the fine structures and sealing the fine structures by precipitating calcium salts by an action of residual high alkali components, it becomes possible to inhibit the relapse.

For contaminated dentin, a biofilm which is formed in dentinal tubule within contaminated dentin is a subject. By dressing with a calcium preparation after washing, the calcium salts are precipitated on dentinal tubule. In case of enamel, the biofilm which is formed in fractures in enamel rod (prism) is a subject.

Next, explanations will be given regarding a body tissue (i.e., infected periodontal tissue). When the treatment is carried out, it is absolutely necessary to examine a periodontal pocket right before the treatment and determine the state of epithelium in the periodontal pocket and the depth of the periodontal pocket. First, when it is found out by an examination of a periodontal pocket that the periodontal pocket is prone to bleeding, as the inside of the periodontal pocket consists of young granulation tissues and continuity of the epithelium in the pocket is disrupted, the aqueous solution of the present invention is used at low concentration instead of high concentration from the viewpoint of damage on tissues.

When there is no hemorrhage found by the examination of the periodontal pocket, continuity of stratified squamous epithelium is maintained in the periodontal pocket and invasion into a human body by passing through the defense barrier of the epithelium is not likely to occur. Thus, it can be said that this is a state from which a more favorable effect can be obtained by using the aqueous solution of the present invention at high concentration.

As a result of the treatment, the alkaline property is maintained for a certain period of time due to the presence of calcium salts in the fine fractures within the tooth hard tissues, wherein the salts are precipitated by an action of the aqueous solution of the present invention. Regarding a periodontal pocket, it is known that Gingival Cervicular Fluid (GCF) is leaked therefrom. However, this component is so-called a compound liquid of body fluid and contaminants, and known to include also the components of blood.

Meanwhile, it is known that the blood calcium ion concentration is supersaturated compared to a bone. Based on this, the residual alkali that is precipitated in fine fractures in the cementum after the treatment is supplied with calcium ions from GCF, and the fine fractures continue to get calcified according to precipitation of the calcium salt. For contaminated dentin, the calcium salt is supplied by dressing with a calcium preparation for dental use. By repeating this treatment using a drug solution injection type ultrasonic scaler, etc., gradually the biofilm component in contaminated cementum is removed and the fine fractures are sealed.

Next, removal of the contaminants (i.e., biofilm) in contaminated tooth hard tissues and an agent for re-calcification used for the contaminated tooth hard tissues will be explained.

The aqueous solution of the present invention takes advantage of the washing effect of sodium hypochlorite as a basic washing element for a biofilm component, the washing effect of an alkali (OH⁻) and the washing effect of a surface active agent.

FIG. 4 is a diagram illustrating the effect of pH of a washing liquid on desorption of BSA that is irreversibly adsorbed on the surface of α-Al₂O₃ and desorption of biofilm-forming bacteria. The vertical axis indicates the removal ratio and the horizontal axis indicates pH. BSA is hardly desorbed in a weakly acidic to weakly alkali range, but both the removal ratio and desorption rate are significantly increased with the increase of pH in an alkali region, in particular the pH region of 11.5 to 13. The relationship between pH and the removal ratio of biofilm-forming bacteria shows the same tendency as BSA. In addition, pectin, an acid polysaccharide, is desorbed in an acidic pH region but its removal ratio and the desorption rate are dependent on OH⁻ concentration, similar to the protein (excerpt from “Characteristics of washing and removal of biofilm components based on washing,” Hiromi URANO, Bokin Bobai Vol. 37, No. 2, pp. 139 to 147, 2009).

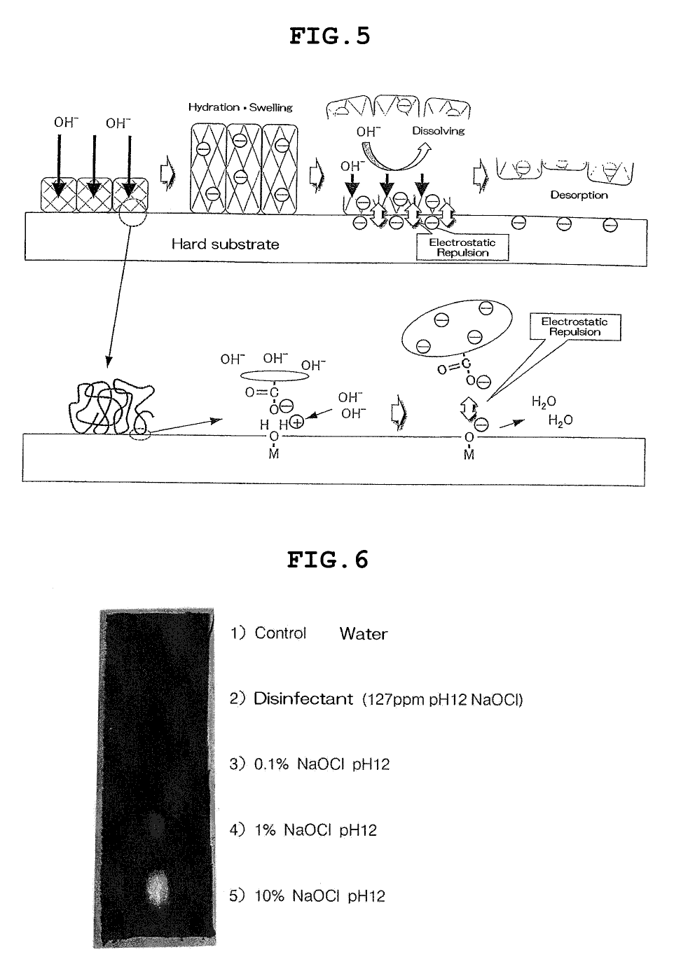

FIG. 5 is a diagram illustrating a model mechanism of washing and removing the components of a biofilm by OH⁻. Under the alkali condition having high OH⁺ concentration, H⁺ of a carboxyl group, etc. in components of a biofilm is desorbed and molecular chains of a biofilm-constituting component or a surface layer of bacterial cells have a negative charge, accelerating hydration, swelling, dissolving and dispersion thereof. In addition, under the highly alkali condition, OH⁻ is adsorbed on a substrate surface, and together with the components of the biofilm, the substrate surface becomes to have a huge negative charge. Consequently, a big electrostatic repulsion is generated with the components of the biofilm, and the adsorption ability is lost as a result of the sum of the interaction, yielding a shift of equilibrium to the direction of desorption. Finally, OH⁻ is adsorbed and substituted at an adsorption site for the components of the biofilm on the substrate surface to eventually cause desorption. In other words, it is believed that an adsorption and substitution reaction by OH⁻ at interface region between a polar substrate surface and water plays an important role in the progress of the washing.

Meanwhile, when there is non-specific and reversible adsorption based on a hydrophobic interaction, pH dependency of the removal ratio appears to be different.

In FIG. 4, the effect of pH of a washing liquid on desorption of BSA, which is adsorbed on the surface of PET, is shown. Within a weakly acidic to weakly alkali region, the removal ratio increases gradually in accordance with an increase in pH. It increases dramatically at a pH of 12 or above. However, as compared with the case in which a polar substrate is used, the removal ratio is low under highly alkali condition having a pH of 12 or above (i.e., high OH⁻ concentration condition). For part of the BSA that is slowly and reversibly adsorbed based on a hydrophobic interaction, also in a weakly acidic to weakly alkali region, a negative charge is obtained by desorption of H⁺ of a carboxyl group, etc. according to an increase in OH⁻, and hydration, swelling, dissolution and dispersion are promoted and the desorption occurs easily. Meanwhile, under the highly alkali condition, it is believed that the BSA remaining on the outermost surface of a substrate cannot have an electrostatic repulsion between BSA molecules in a state having little adsorption amount and, as the number of adsorption sites for OH⁻ on a substrate surface is small and a density of a negative charge is significantly low, the electrostatic repulsion between BSA and the substrate surface or the activity of promoting the desorption by adsorption and substitution of OH⁻ cannot be obtained, and therefore the desorption does not occur (excerpt from “Characteristics of washing and removal of biofilm components based on washing,” Hiromi URANO, Bokin Bobai Vol. 37, No. 2, pp. 139 to 147, 2009).

FIG. 6 is a diagram illustrating a comparison result of an effect between a conventional oral cavity disinfectant and a therapeutic agent for periodontal diseases of the present invention.

As an implementation method, 10% aqueous sodium hypochlorite solution and 0.01 mol/L aqueous sodium hydroxide solution (pH 12) were used as liquid A and liquid B, respectively, to prepare an aqueous sodium hypochlorite solution (pH 12) having a different concentration and a pH of 12 to which sodium hydroxide was added. The test results are shown in FIG. 6.

1) Water (control) . . . no

2) Disinfectant (127 ppm) . . . no change

3) 0.1% aqueous sodium hypochlorite solution . . . impossible to recognize a change

4) 1% aqueous sodium hypochlorite solution . . . decoloration

5) 10% aqueous sodium hypochlorite solution strong decoloration

From the above results, it is found that 5) 10% aqueous sodium hypochlorite solution plus pH 12 has the strongest effect.

Next, the drug solution which is related to the present invention will be explained. The drug solution of the present invention is an aqueous solution comprising hypochlorous acid or sodium hypochlorite, and the aqueous solution has effective chlorine concentration of 0.1 ppm to 100000 ppm and a pH of 7 to 13, and contains sodium hypochlorite or sodium dichloroisocyanurate, and sodium hydroxide (NaOH), sodium hydrogen carbonate (NaHCO₃) or sodium carbonate (Na₂CO₃).

In addition, expecting an enhancement in the washing effect, a non-ionic surface active agent may be added.

As an effect expected from the aqueous solution of the present invention, it can chemically dissolve and remove a biofilm which is formed in fine fractures within a contaminated tooth hard tissue and, by precipitating calcium ions in the biofilm as a calcium salt at a high pH, it plays a role of assisting the sealing of the fine fractures that are anatomically present.

With respect to hypochlorous acid (sodium hypochlorite), it has been already shown that in washing of a biofilm the washing power of sodium hypochlorite is dependent on the concentration of OCl⁻ and the washing effect is improved as pH increases. In particular, at the concentration of 100 mg/L (100 ppm) or above, the washing effect is improved. With respect to the washing effect of a hydroxide ion (OH⁻), it is also reported that the removal ratio of a biofilm is dependent on OH⁻ concentration. Although the dissolution ratio is low in a neutral to alkali region, in the range of pH 11 to pH 13 the washing effect is dramatically improved in accordance with the increase in OH⁻ concentration.

It is reported that, when a sodium hypochlorite solution is used under an alkali condition of pH 11 or above in which the washing effect of OH⁻ increases, the washing power is dramatically improved based on a potentiation between OH⁻ and OCl⁻.

The aqueous solution of the present invention is an aqueous electrolyte solution and its equilibrium state is decided by pH. When applied to a human body, it is assumed that the aqueous solution of the present invention is used for the inside of a periodontal pocket in which contaminated cementum is present. Even when it is strongly alkaline, it has almost no effect on a human body if it is an aqueous solution with low concentration. pH is an index of molar concentration of [H⁺] or [OH⁻] in an aqueous solution. pH 13 indicates, in case of sodium hydroxide (molecular weight of about 40), 0.1 mol/L=4 g/L. In case of sodium hydroxide, approximately 300 ppm to 1000 ppm is believed to be preferable, in terms of concentration in an aqueous solution.

Likewise, if concentration of sodium hypochlorite has no influence on a human body, it is within the range that can be effectively used without having an influence on a human body. In terms of effective chloride concentration, approximately 50 ppm to 10000 ppm is preferable.

It is generally known that sodium hypochlorite has chlorine odor. That is because, when an aqueous solution of sodium hypochlorite is an acidic aqueous solution, more of the free effective chlorines in water become to be in the form of Cl₂ component, and as a result, chlorine odor is generated in accordance with volatilization of chlorine gas. Because the aqueous solution of the present invention is alkaline, free effective chlorines in water are in the form of OCl⁻, and therefore chlorine odor is hardly generated.

Furthermore, when applied to contaminated dentin, it dissolves a biofilm which is formed in the dentinal tubule, making it possible to remove an antigenic substance.

When the contaminated dentin is in the form of infected root canal, the aqueous solution of the present invention is filled within the root canal and shut off from an oral mucous membrane, and therefore it is highly safe. In case of contaminated dentin which is caused by decay of the dentin but does not reach the root canal, the aqueous solution of the present invention can be contained in a cotton swab, etc. and then added to an application site.

Next, the action mechanism of the aqueous solution of the present invention will be explained. OCl⁻ and OH⁻ from sodium hypochlorite and sodium hydroxide in the aqueous solution are used as an oxidizing-reduction agent in the present invention, and the concentration of the oxidizing-reduction agent not only exhibits the washing effect but also determines cellular toxicity.

In the aqueous solution of the present invention, under high OH⁻ condition, OH⁻ forms a hydrated layer of OH⁻ on a surface of a substance to which it is adsorbed, and by giving huge negative charges on both, it exhibits an excellent dissolving power for a broad range of organic matter like proteins, polysaccharides, oils and fats, etc.

OCl⁻ exhibits a strong oxidizing action against a residue having high electron density like C═C, C═N, C—N, —NH₂ and —SH, etc. that are commonly present on a surface layer of a protein, a polysaccharide, or a microorganism cell. The washing activity of sodium hypochlorite against organic contamination is obtained by a synergistic effect between a washing promoting activity by hypochlorous acid (HOCl) of accelerating desorption by oxidation and decomposition and a dissolving power by NaOH.

At the time of decomposing and removing a biofilm by use of the aqueous solution of the present invention, the Ca ions present in the biofilm cannot be present as an ion under an alkali environment, and therefore is precipitated as Ca salt. As the Ca salt exhibits an alkali property, the precipitates keep having a local alkali property, and therefore the precipitation of the Ca salt is promoted.

The aqueous solution of the present invention has a property of an electrolyte solution and its pH is changed even to a neutral region according to neutralization by proteins, etc. that are included in saliva or a biofilm, etc. during treatment. At that moment, according to Le Chatelier's principle, there is a tendency for the aqueous solution to obtain a new equilibrium state. Thus, even when the aqueous solution passes through an oral cavity and enters a stomach, it is neutralized by stomach acid (pH 2). Considering a case in which sodium hydroxide is applied to a cell in a disrupting manner, as a cell membrane consists of a saturated fatty acid and an unsaturated fatty acid, the product which is obtained by reaction with sodium hydroxide is that known as a component of so-called a “soap.” Thus, even when a small amount of a soap component is formed and swallowed, there is no effect on a human body.

The epithelium component in an oral cavity is stratified squamous epithelium. Among the cells between the epitheliums, an extracellular material like chondroitin sulfate, hyaluronic acid and dermatan sulfate, etc., which are well known as a moisturizing ingredient, is present. In fact, in order for an aqueous solution of sodium hydroxide to pass through the epithelium and damage a human body, a solution with very high concentration is required. Thus, with only a small amount of sodium hydroxide, a problem will not arise in terms of use for a human body.

In addition, it is also possible to use the solution by including a small amount of a non-ionic surface active agent. It is an aqueous solution by which contaminants are converted into colloid by the surface active agent to enhance the inhibition of the re-adsorption. There is also a report indicating that the washing effect is increased by addition of a small amount of a non-ionic surface active agent.

When taken together the above, according to conventional technologies, 1) an antibiotic substance was used, as mentioned as a substance for removal of a biofilm, 2) it was aimed to achieve sterilization by using a bactericidal substance, 3) it was possible to remove the contaminants only on surface layer of contaminated cementum, 4) an antigenic substance present inside contaminated cementum was dealt with mechanical removal, 5) they were useless for removal of a biofilm present in fine fractures that were anatomically visible, and 6) no consideration was given to sealing of the fine fractures that were anatomically visible.

In this regard, the present invention is distinguished in that 1) the main activity is not obtained from an antibacterial agent, an enzyme or a surface active agent (when added, the surface active agent is only used as an aid), 2) it does not have bacteria as a target (instead, molecules like proteins, sugars, oils and fats, etc. that are not an living organism but molecules smaller than bacteria), 3) the antigenic substance inside the contaminated tooth hard tissue is a subject (the subject site is the inside of a periodontal tissue and the inside of a tooth hard tissue), 4) a biofilm present in anatomically visible fine fractures can be removed (until now, there has been no report regarding chemical dissolution), 5) the anatomically visible fine fractures can be sealed by precipitation of Ca salt (i.e., a chemical precipitation and deposition reaction of calcium salt under an alkali environment, as learned in chemistry class of high school), 6) anesthesia as a pretreatment for relieving pain is hardly required, because no metal device like a scaler, etc. is used, 7) shortening of treatment time is expected, and 8) the treatment effect is continuously obtained for a certain period of time (based on the precipitation of calcium salt).

According to the present invention, contaminated cementum is infiltrated with an aqueous solution to dissolve and remove the contaminants that are formed inside the contaminated cementum and fine structures within the cementum are sealed based on precipitation of a calcium salt caused by an alkali component contained in the residual aqueous solution, and therefore not only the biofilm in hard tissues is removed but also the hard tissues are re-calcified to prevent the relapse of periodontal diseases.

Furthermore, as the washing effect is dramatically improved in accordance with the increase in OH⁻ concentration in the range of pH 11 to pH 13, it becomes possible to ensure the human safety and increase dramatically the biofilm removal ratio.

Furthermore, even when the therapeutic agent for periodontal diseases of the present invention passes through an oral cavity and enters a stomach, it is neutralized by stomach acid (pH 2), and therefore a bad influence on a human body can be prevented.

Furthermore, by having and using a small amount of a non-ionic surface active agent, contaminants are converted into colloid by the surface active agent to potentiate the inhibition of their re-adsorption. Accordingly, the washing effect can be enhanced.

Still furthermore, as the washing is carried out by applying the aqueous solution of the present invention on a surface of contaminated cementum for the infiltration into contaminated cementum, a contaminant (i.e., a biofilm) present in fine structures can be removed and the fine structures can be sealed by precipitation of calcium salts by an action of residual high alkali components, and as a result, it becomes possible to inhibit the relapse.

1. A therapeutic agent for periodontal diseases by which a biofilm formed inside hard tissues in an oral cavity is removed and the hard tissues are re-calcified,
wherein the biofilm formed in a fine fracture within contaminated tooth hard tissues is chemically dissolved and removed and calcium ions contained in the biofilm are precipitated as a calcium salt under an alkali condition so that the anatomically present fine fracture is sealed by the precipitated salt.

2. The therapeutic agent for periodontal diseases according to claim 1,
wherein the therapeutic agent for periodontal diseases is an aqueous solution comprising hypochlorous acid or sodium hypochlorite and the aqueous solution has an effective chlorine concentration of 0.1 ppm to 100000 ppm and a pH value of 7 to 13 and contains the sodium hypochlorite or sodium dichloroisocyanurate, and sodium hydroxide, sodium hydrogen carbonate or sodium carbonate.

3. The therapeutic agent for periodontal diseases according to claim 1,
wherein the aqueous solution is an aqueous electrolyte solution and an equilibrium state is determined by the pH value.

4. The therapeutic agent for periodontal diseases according to claim 1,
wherein a non-ionic surface active agent is added to the aqueous solution.

5. A method of treating periodontal diseases, wherein the biofilm formed inside the hard tissues is removed by infiltrating a periodontal pocket having contaminated cementum with the therapeutic agent for periodontal diseases described in claim 1.

6. The therapeutic agent for periodontal diseases according to claim 2,
wherein the aqueous solution is an aqueous electrolyte solution and an equilibrium state is determined by the pH value.

7. The therapeutic agent for periodontal diseases according to claim 2,
wherein a non-ionic surface active agent is added to the aqueous solution.

8. The therapeutic agent for periodontal diseases according to claim 3,
wherein a non-ionic surface active agent is added to the aqueous solution.

9. A method of treating periodontal diseases, wherein the biofilm formed inside the hard tissues is removed by infiltrating a periodontal pocket having contaminated cementum with the therapeutic agent for periodontal diseases described in claim 2.

10. A method of treating periodontal diseases, wherein the biofilm formed inside the hard tissues is removed by infiltrating a periodontal pocket having contaminated cementum with the therapeutic agent for periodontal diseases described in claim 3.

11. A method of treating periodontal diseases, wherein the biofilm formed inside the hard tissues is removed by infiltrating a periodontal pocket having contaminated cementum with the therapeutic agent for periodontal diseases described in claim 4.
